(19) United States
(12) Patent Application Publication
(10) Pub. No.: US 2025/0049237 A1
(43) Pub. Date: Feb. 13, 2025

(54) MULTILAYERED PILLOW PROTECTOR

(71) Applicant: Herbert M Walker, Grand Prairie, TX (US)

(72) Inventor: Herbert M Walker, Grand Prairie, TX (US)

(21) Appl. No.: 18/921,992

(22) Filed: Oct. 21, 2024

Related U.S. Application Data
(63) Continuation of application No. 18/433,136, filed on Feb. 5, 2024, now abandoned.
(60) Provisional application No. 63/522,792, filed on Jun. 23, 2023.

(51) Int. Cl. A47G 9/02; B32B 5/02; B32B 5/26; B32B 7/08

(52) U.S. Cl. CPC A47G 9/0253; B32B 5/022; B32B 5/266; B32B 7/08; B32B 2601/00

(57) ABSTRACT

A multi-layered pillow protector includes a first panel; a second panel that is perimetrically joined to the first panel such that the inner surfaces of the first panel and the second panel define a cavity having a void volume configured for the disposal of a pillow from one side; a plurality of appended panels adjoined externally along one of the sides of the first panel and the second panel with the rest of the sides of each of the appended panels independently accessible to move to form a plurality of layers on the first panel and second panel; and each of the plurality of appended panels can be interchangeably used as head resting surfaces by flipping over the first and second panels.

### BACKGROUND

### 1. Field of the Invention

The present invention relates generally to pillow systems, and more specifically to a multi-layered pillow protector with a plurality of interchangeable head-resting surfaces.

### 2. Description of Related Art

Sleep is critical for people to feel and perform their best, in every aspect of their lives. Sleep is an essential path to better health and reaching personal goals. Indeed, sleep affects everything from the ability to commit new information to memory to weight gain. It is therefore essential for people to use bedding that suits both their personal sleep preference and body type to achieve comfortable, restful sleep.

Pillows have been developed to suit various sleep preferences and body types by, for example, providing support to certain portions of a person's anatomy, such as, for example, the person's spine. Such pillows are typically covered using a conventional pillow protector, which is essentially a bag that is formed out of fabric or other material into which a pillow may be disposed.

Pillow protectors help keep an underlying pillow clean and allow a user to launder the case rather than the pillow itself and therefore extend the useful life of the pillow. However, some users require frequent pillow protector changes due to illness, sores, allergies to dander, etc. Frequent changing of a pillow protector may maintain a hygienic or sanitary sleeping surface but requires high maintenance. In their conventional form, pillow protectors have only two sides which may be soiled or otherwise contaminated after only two nights of use.

A pillow protector may be ideally laundered every few days to maintain a healthy sleeping environment but this is not usually the case. Usually, pillow protectors go without being laundered for many days and even weeks, allowing sweat, saliva, dirt, natural oils, dandruff, hair, and makeup to accumulate thereon. The ideal situation is to have a pillow protector that provides a clean sleeping surface to the user every single night without the maintenance hassle of daily laundry or daily changes.

Additionally, medical patients and otherwise ill people may recover from sickness faster avoiding exposure to germs that they would be exposed to when a pillow case does not get frequently changed. Those who drool in their sleep or tend to forget to remove their makeup may also benefit from a fresh pillow protector. Others who do not wash their sheets or pillow protectors often enough will also benefit including students, travelers, and those who do not own a washer and dryer or otherwise have the means to get to a laundry shop.

The problems commonly associated with conventional pillow systems and their extended use often result in unhealthy facial skin and cause acne and wrinkles, and their rough surface increases fine lines and causes damaged and aged skin.

Accordingly, although great strides have been made in the area of pillow systems, many shortcomings remain.

### DESCRIPTION OF THE DRAWINGS

The novel features believed characteristic of the embodiments of the present application is set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front perspective view of a multi-layered pillow protector showing appended panels, according to the preferred embodiment of the invention;

FIG. 2 is a side perspective view of a multi-layered pillow protector of FIG. 1;

While the multi-layered pillow protector and method of use of the present application are susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the multi-layered pillow protector and the method of use of the present application are provided below. It will be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The multi-layered pillow protector and method of use in accordance with the present application overcome one or more of the above-discussed problems commonly associated with conventional pillow systems. Specifically, the multi-layered pillow protector of the present invention provides a pillow protector with multiple layers of head-resting surfaces that can be interchanged every day to maintain hygiene to promote smooth and healthy skin. These and other unique features of the multi-layered pillow protector and method of use are discussed below and illustrated in the accompanying drawings.

The multi-layered pillow protector and method of use will be understood, both as to its structure and operation, from the accompanying drawings, taken in conjunction with the accompanying description. Several embodiments of the multi-layered pillow protector are presented herein. It should be understood that various components, parts, and features of the different embodiments may be combined and/or interchanged with one another, all of which are within the scope of the present application, even though not all variations and particular embodiments are shown in the drawings. It should also be understood that the mixing and matching of features, elements, and/or functions between various embodiments are expressly contemplated herein so that one of ordinary skill in the art would appreciate from this disclosure that the features, elements, and/or functions of one embodiment may be incorporated into another embodiment as appropriate unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

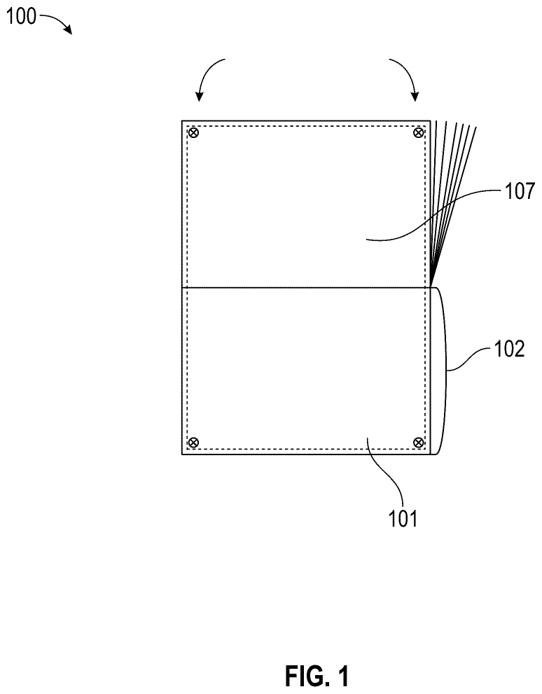

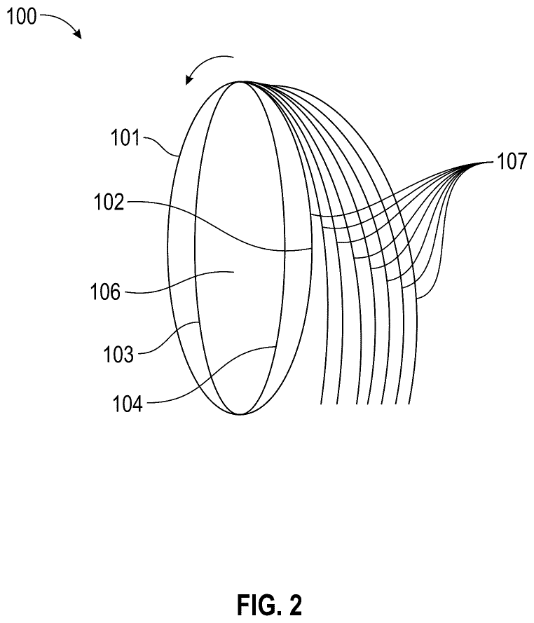

Referring now to the drawings wherein reference characters identify corresponding or similar elements throughout the several views, FIGS. 1-2 depict the multi-layered pillow protector in accordance with a preferred embodiment of the present application. It will be appreciated that multi-layered pillow protector 100 overcomes one or more of the above-listed problems commonly associated with conventional pillow systems. In addition, it should be appreciated that more or fewer such components may be included in different embodiments of the multi-layered pillow protector 100.

In the contemplated embodiment, there is provided a multi-layered pillow protector 100 includes a first panel 101 and a second panel 102 perimetrically joined with first panel 101 such that inner surfaces 103, 104 of first and second panels 101, 102 define a cavity 105 having a void volume configured for disposal of a pillow 106 from one side. First and second panels 101, and 102 each have a rectangular cross-sectional configuration such that cavity 105 has a size and shape that conforms to that of a standard-size pillow.

In the contemplated embodiment, the multi-layered pillow protector 100 further includes, a plurality of appended panels 107 adjoined externally along one of the sides of the first panel 101 and the second panel 102 with the rest of the sides of each of the appended panels 107 independently accessible to move to form a plurality of layers on the first panel 101 and second panel 102. Each of the plurality of appended panels 107 can be interchangeably used as head resting surfaces.

In the contemplated embodiment, the plurality of appended panels 107 of the multi-layered pillow protector 100 can be any number of appended panels, preferably the number of appended panels can be seven, each appended panel for each night's sleep in a week.

In the contemplated embodiment, the plurality of appended panels 107 of the multi-layered pillow protector 100 can be used for head resting or for different purposes and can be of any size, shape, material, thickness, or design.

In the contemplated embodiment, when not in use, all of the appended panels 107 are layered onto the second panel 102, and the first panel 101 is displayed. The first panel 101 is preferably for decorative purposes and display when the pillow protector 100 is not used for resting the head by the user.

In the contemplated embodiment, when in use, each of the appended panels 107 can be interchangeably layered onto the first panel 101 for each episode of head resting or for a night's sleep. The appended panels that are not in use for head resting can be layered onto the second panel 102 or layered between the appended panel currently in use and the first panel 101.

In the contemplated embodiment, the multi-layered pillow protector 100 provides a reusable hygienic head-resting surface for each episode of head resting or for a night's sleep. The appended panels promote skin rejuvenation, reduce wrinkles, improve skin texture, reduce fine lines, and improve overall skin health by reducing the spread of harmful and acne-causing bacteria, viruses, and other infection-causing microbes. The multi-layered pillow protector 100 provides a clean and smooth surface for resting the user's head every night and is gentle on the facial skin of people with acne or sensitive skin and has an anti-aging effect.

In some embodiments, first panel 101, second panel 102, and/or cavity 105 may have various cross-section configurations, such as for example, oval, oblong, triangular, rectangular, square, polygonal, irregular, uniform, non-uniform, variable, tubular and/or tapered. In some embodiments, the inner surface 103 is continuous with the inner surface 104 such that cavity 105 is completely enclosed by first and second panels 101, and 102.

At least one of the first and second panels 101, 102, and appended panels 107 is made from a first material, such as, for example, a breathable fabric. In some embodiments, at least one of the first and second panels 101, and 102 and appended panels 107 is made from a compliant fabric. In some embodiments, at least one of first and second panels 101, 102, and appended panels 107 is made from a moisture-absorbing fabric, such as, for example, single layer 100% polyester fiberfill fabric, multi-layer (e.g., triple layer) 100% polyester fiberfill fabric, a polyester fabric, 100% polyester fabric, rayon, nylon, 3D spacer fabric, cotton-polyester blend fabric or spandex-blend fabric. In some embodiments, at least one of the first and second panels 101, 102, and appended panels 107 is made from an elastic material, such as, for example, a polyester/spandex blend of knit fabric to provide maximum stretch for conforming fit and heat and moisture-absorbing.

In some embodiments, at least one of the first and second panels 101, and 102, and appended panels 107 are made from 100% polyester knit, 100% natural fabrics, natural fibers (cotton blended with elastic fibers), or man-made materials. In some embodiments, at least one of the first and second panels 101, 102, and appended panels 107 is made from a fabric that is not moisture-repellant. In some embodiments, at least one of the first and second panels 101, 102, and appended panels 107 is made from a moisture-dispersing material. In some embodiments, at least one of the first and second panels 101, 102, and appended panels 107 is made from a nonwoven material.

In the contemplated embodiment, at least one of the first and second panels 101, 102, and appended panels 107 is made from any suitable material including but not limited to a fabric spun from bamboo, silk, satin, polyester, or cotton.

The appended panels 107 are securable to each other and the first and second panels 101 and 102 via a fastener on each of the appended panels and a complementary fastener disposed respectively on the first and second panels 101 and 102. Disclosed fasteners include magnets, hook and loop, grommet and tie, button and buttonhole pairs, ganged hole and post fasteners, and the like.

The fasteners can be disposed of in each corner of each layer, preferably with a fastener in the center of the other two fasteners located at the corners.

The multi-layered pillow protector 100 can be used to provide a clean sleeping surface every night without daily laundering or daily changes. Hygienic sleeping surfaces accordingly provide a multitude of benefits for different users with differing circumstances. The multi-layered pillow protector 100 can be beneficial in reducing and controlling the spread of acne, skin infections, allergies, dandruff, and other skin and scalp conditions.

It is also contemplated and will be appreciated that the multi-layered pillow protector 100 of the present invention is easy to use, completely safe on the skin, eco-friendly, and provides a reusable pillow protector that can provide a fresh and clean surface for head resting every night.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments but are amenable to various changes and modifications without departing from the spirit thereof.

What is claimed is:

1. A multi-layered pillow protector, comprising:
a first panel;
a second panel that is perimetrically joined to the first panel such that the inner surfaces of the first panel and the second panel define a cavity having a void volume configured for the disposal of a pillow from one side;
a plurality of appended panels adjoined externally along one of the sides of the first panel and the second panel with the rest of the sides of each of the appended panels independently accessible to move to form a plurality of layers on the first panel and second panel;
wherein each of the plurality of appended panels can be interchangeably used as head resting surfaces by flipping over the first and second panels.

2. The multi-layered pillow protector, wherein the first panel and the second panel are composed of a fabric spun from bamboo, silk, satin, polyester, or cotton.
